(19) United States
(12) Patent Application Publication
(10) Pub. No.: US 2018/0300466 A1
(43) Pub. Date: Oct. 18, 2018

(54) METHOD AND APPAPRATUS FOR CONTROLLING ELECTRONIC DEVICE, AND ELECTRODE DEVICE

(71) Applicant: BOE TECHNOLOGY GROUP CO., LTD., Beijing (CN)

(72) Inventor: Xin LI, Beijing (CN)

(73) Assignee: BOE TECHNOLOGY GROUP CO., LTD., Beijing (CN)

(21) Appl. No.: 15/525,977

(22) PCT Filed: Jan. 5, 2016
(86) PCT No.: PCT/CN2016/070177

§ 371 Date: May 11, 2017

(30) Foreign Application Priority Data
Aug. 21, 2015 (CN) 201510520394.8

(51) Int. Cl. G06F 21/32

(52) U.S. Cl. CPC G06F 21/32; G06F 2221/2105

(57) ABSTRACT

The present disclosure provides a method and an apparatus for controlling an electronic device, and the electronic device. The electronic device includes a collection unit. The method includes: an acquisition step of, in a locked state, acquiring source physiological characteristic data of a user through the collection unit, a first authentication step of performing first authentication in accordance with the source physiological characteristic data and target physiological characteristic data stored in a database, and acquiring a first authentication result, a second authentication step of, in the case that the first authentication result indicates that authentication is unsuccessful, performing second authentication using an auxiliary authentication mode different from a physiological characteristic authentication mode, and acquiring a second authentication result, and a storage step of, in the case that the second authentication result indicates that authentication is successful, storing the source physiological characteristic data in the database.

### CROSS-REFERENCE TO RELATED APPLICATION

The present application claims a priority of the Chinese patent application No. 201510520394.8 filed on Aug. 21, 2015, which is incorporated herein by reference in its entirety.

### TECHNICAL FIELD

The present disclosure relates to the field of electronic device security technology, in particular to a method and an apparatus for controlling an electronic device, and the electronic device.

### BACKGROUND

Currently, such electronic devices as mobile phones, Personal Digital Assistants (PDAs) and laptop computers have been widely used in our daily lives, and more and more privacy data, such as photos, credit card numbers and house addresses may be stored in the electronic devices.

In order to ensure the security of the privacy data, various authentication modes, e.g., an authentication mode on the basis of physiological characteristics (such as fingerprint, iris and face characteristics), a multi-point touch authentication mode on the basis of a touch trajectory and an authentication mode on the basis of characters, have currently been applied to an identical electronic device.

Although the authentication modes on the basis of the physiological characteristics (such as fingerprint, iris and face characteristics) and the other authentication modes are applied to an identical electronic device, these authentication modes may operate separately, so the convenience of the user's operation will be adversely affected.

### SUMMARY

An object of embodiments of the present disclosure is to provide a method and an apparatus for controlling an electronic device and the electronic device, so as to facilitate the user's operation and improve the convenience of the electronic device.

In one aspect, the present disclosure provides in some embodiments a method for controlling an electronic device having a collection unit configured to collect source physiological characteristic data of a user, the method including: an acquisition step of, in a locked state, acquiring the source physiological characteristic data of the user through the collection unit; a first authentication step of performing first authentication in accordance with the source physiological characteristic data and target physiological characteristic data stored in a database, and acquiring a first authentication result; a second authentication step of, in the case that the first authentication result indicates that authentication is unsuccessful, performing second authentication using an auxiliary authentication mode different from a physiological characteristic authentication mode, and acquiring a second authentication result; and a storage step of, in the case that the second authentication result indicates that authentication is successful, storing the source physiological characteristic data in the database.

In a possible embodiment of the present disclosure, the method further includes a first control step of, in the case that the second authentication result indicates that authentication is unsuccessful, controlling the electronic device to operate in a guest mode where the user is merely capable of using parts of functions of the electronic device.

In a possible embodiment of the present disclosure, the method further includes a second control step of, in the case that the second authentication result indicates that authentication is unsuccessful, performing a security control operation.

In a possible embodiment of the present disclosure, the method further includes a trigger control step of, in the case that the first authentication result indicates that authentication is unsuccessful, determining whether or not the times of unsuccessful authentication are greater than a predetermined threshold, acquiring a determination result, and in the case that the determination result indicates that the times of unsuccessful authentication are greater than the predetermined threshold, entering the second authentication step, and otherwise returning to the acquisition step.

In a possible embodiment of the present disclosure, the electronic device further includes a touch panel, the physiological characteristic authentication mode is a fingerprint authentication mode, the auxiliary authentication mode is an authentication mode performed on the basis of a user's operation collected by the touch panel, and the collection unit is located at a predetermined region of the touch panel and is capable of collecting user's fingerprint data in the case that a touch operation for unlocking is made by the user at the predetermined region.

In a possible embodiment of the present disclosure, the security control operation includes an electronic device locking operation for preventing data leakage, a data wiping operation for prevent data leakage, and/or an alarm operation for the retrieval of the electronic device.

In another aspect, the present disclosure provides in some embodiments an apparatus for controlling an electronic device, the electronic device including a collection unit configured to collect source physiological characteristic data of a user, the apparatus including: an acquisition unit configured to, in a locked state, acquire the source physiological characteristic data of the user through the collection unit; a first authentication unit configured to perform first authentication in accordance with the source physiological characteristic data and target physiological characteristic data stored in a database, and acquire a first authentication result; a second authentication unit configured to, in the case that the first authentication result indicates that authentication is unsuccessful, perform second authentication using an auxiliary authentication mode different from a physiological characteristic authentication mode, and acquire a second authentication result; and a storage unit configured to, in the case that the second authentication result indicates that the second authentication is successful, store the source physiological characteristic data in the database.

In a possible embodiment of the present disclosure, the apparatus further includes a first control unit configured to, in the case that the second authentication result indicates authentication is unsuccessful, control the electronic device to operate in a guest mode where the user is merely capable of using parts of functions of the electronic device.

In a possible embodiment of the present disclosure, the apparatus further includes a second control unit configured to, in the case that the second authentication result indicates that authentication is unsuccessful, perform a security control operation.

In a possible embodiment of the present disclosure, the apparatus further includes a trigger control unit configured to, in the case that the first authentication result indicates that authentication is unsuccessful, determine whether or not the times of unsuccessful authentication are greater than a predetermined threshold, acquire a determination result, and in the case that the determination result indicates that the times of unsuccessful authentication are greater than the predetermined threshold, trigger the second authentication unit, and otherwise trigger the acquisition unit.

In a possible embodiment of the present disclosure, the electronic device further includes a touch panel, the physiological characteristic authentication mode is a fingerprint authentication mode, the auxiliary authentication mode is an authentication mode performed on the basis of a user's operation collected by the touch panel, and the collection unit is located at a predetermined region of the touch panel and is capable of collecting user's fingerprint data in the case that a touch operation for unlocking is made by the user at the predetermined region.

In a possible embodiment of the present disclosure, the security control operation includes an electronic device locking operation for preventing data leakage, a data wiping operation for prevent data leakage, and/or an alarm operation for the retrieval of the electronic device.

In yet another aspect, the present disclosure provides in some embodiments an electronic device including a collection unit configured to collect source physiological characteristic data of a user, and the above-mentioned apparatus.

The embodiments of the present disclosure have at least one of the following beneficial effects.

1. In the embodiments of the present disclosure, in the case that the current user fails to be authenticated through the physiological characteristic authentication mode but has been authenticated through the other authentication mode different from the physiological characteristic authentication mode, the physiological characteristic of the user collected through the physiological characteristic authentication mode may be directly stored in the database. Hence, it is unnecessary to collect the physiological characteristic of the user again, thereby to reduce the user's operation procedures and improve the convenience of the electronic device.

2. In the embodiments of the present disclosure, in the case that the current user fails to be authenticated through the physiological characteristic authentication mode and fails to be authenticated through the other authentication mode different from the physiological characteristic authentication mode, it means that the current user may be not an owner of the electronic device. At this time, the security control operation may be performed, so as to protect the electronic device and improve the security of the electronic device.

3. In the embodiments of the present disclosure, in the case that the current user fails to be authenticated through the physiological characteristic authentication mode and fails to be authenticated through the other authentication mode different from the physiological characteristic authentication mode, it means that the current user is merely a guest rather than the owner of the electronic device. In this case, the electronic device may operate in a guest mode, so as to enable the current user to merely use parts of the functions of the electronic device, thereby to protect the privacy data while sharing the electronic device.

4. In the embodiments of the present disclosure, considering that an error occurs for the collection and authentication of the physiological characteristic, the physiological characteristic authentication may be performed for several times, and in the case that the authentication times has reached the predetermined threshold, the physiological characteristic authentication may be deemed to be failed. In this way, it is able to reduce the requirements on the authentication precision for the electronic device, thereby to reduce the manufacture cost of the electronic device.

5. In the embodiments of the present disclosure, the physiological characteristic authentication mode is the fingerprint authentication mode, and in the case that the electronic device includes a touch panel and the authentication mode is performed on the basis of the user's operation collected by the touch panel, the collection unit may be arranged in such a manner as to collect the fingerprint data of the user in the case that the touch operation for unlocking is made by the user at the predetermined region. In this way, it is able for the electronic device to identify the user's fingerprint while collecting the touch data, thereby to simplify the user's operation and improve the convenience of the electronic device.

### BRIEF DESCRIPTION OF THE DRAWINGS

FIG. 1 is a flow chart of a method for controlling an electronic device according to one embodiment of the present disclosure;

FIG. 2 is another flow chart of the method for controlling the electronic device according to one embodiment of the present disclosure;

FIG. 3 is yet another flow chart of the method for controlling the electronic device according to one embodiment of the present disclosure;

FIG. 4 is still yet another flow chart of the method for controlling the electronic device according to one embodiment of the present disclosure;

FIG. 5 is a schematic view showing an apparatus for controlling an electronic device according to one embodiment of the present disclosure;

FIG. 6 is another schematic view showing the apparatus for controlling the electronic device according to one embodiment of the present disclosure; and

FIG. 7 is yet another schematic view showing the apparatus for controlling the electronic device according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

According to the embodiments of the present disclosure, in the case that a current user fails to be authenticated through a physiological characteristic authentication mode but has been authenticated through the other authentication mode different from the physiological characteristic authentication mode, a physiological characteristic of the user collected through the physiological characteristic authentication mode may be directly stored in a database. Hence, it is unnecessary to collect the physiological characteristic of the user again, thereby to reduce the operation procedures of the UE and improve the convenience of an electronic device.

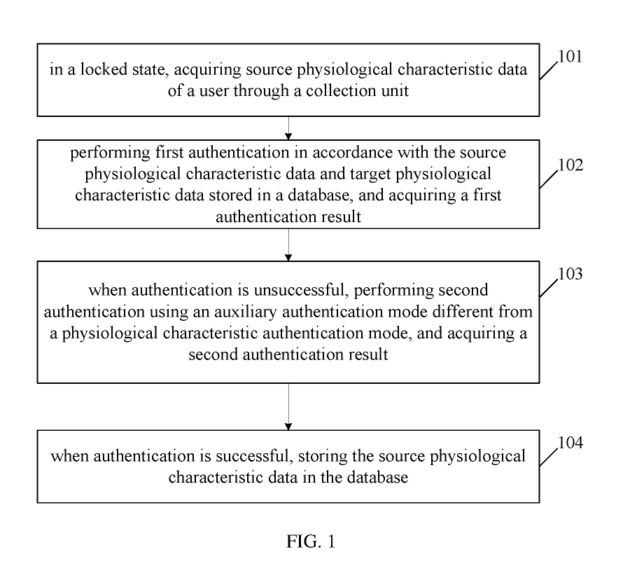

The present disclosure provides in some embodiments a method for controlling an electronic device. The electronic device includes a collection unit to collect source physiological characteristic data of a user. As shown in FIG. 1, the method includes: an acquisition step 101 of, in a locked state, acquiring the source physiological characteristic data of the user through the collection unit; a first authentication step 102 of performing first authentication in accordance with the source physiological characteristic data and target physiological characteristic data stored in a database, and acquiring a first authentication result; a second authentication step 103 of, in the case that the first authentication result indicates that the authentication is unsuccessful, performing second authentication using an auxiliary authentication mode different from a physiological characteristic authentication mode, and acquiring a second authentication result; and a storage step 104 of, in the case that the second authentication result indicates that the authentication is successful, storing the source physiological characteristic data in the database.

According to the method in the embodiments of the present disclosure, in the case that a current user fails to be authenticated through the physiological characteristic authentication mode but has been authenticated through the other authentication mode (hereinafter referred to as auxiliary authentication) different from the physiological characteristic authentication mode, the physiological characteristic of the user collected through the physiological characteristic authentication mode may be directly stored in the database. Hence, it is unnecessary to collect the physiological characteristic of the user again, thereby to reduce the user's operation procedures and improve the convenience of an electronic device.

Fingerprint refers to scraggy lines on the skin of a finger tip, and it includes a large amount of information. For different persons, these lines are different in terms of patterns, breakpoints and intersections, and during the information processing, they may be called as “characteristics”. In addition, these characteristics are unique and permanent. Hence, during the fingerprint authentication, a specific person may be associated with his fingerprint and authenticated by comparing his fingerprint characteristic with a pre-stored fingerprint characteristic.

Similarly, such unique physiological characteristic as iris and face of the user may also be used to authenticate the user.

Due to the uniqueness of the physiological characteristic, this authentication mode is extremely secure. In the embodiments of the present disclosure, the first authentication mode may use this authentication mode on the basis of the physiological characteristic (e.g., the fingerprint characteristic, the iris characteristic or the face characteristic).

In some embodiments of the present disclosure, the auxiliary authentication mode may be any authentication mode different from the physiological characteristic-based authentication mode, e.g., a multi-point touch authentication mode on the basis of a touch trajectory or an authentication mode on the basis of characters.

In some embodiments of the present disclosure, the electronic device may be various electronic devices such as a mobile phone, a flat panel computer, a laptop computer or a PDA. The type of the electronic device is not directly associated with the scheme in the embodiments of the present disclosure, and thus will not be particularly defined herein.

In the related art, different authentication modes for an identical electronic device are independent of each other. However, in the embodiments of the present disclosure, in the case that the current user fails to be authenticated through the physiological characteristic authentication mode, any other authentication mode different from the physiological characteristic authentication mode may be automatically selected. Through the association between the two authentication modes, it is unnecessary for the user to call the other authentication mode, so it is able to improve the user experience to some extent.

The above description is given in the case that the user fails to be authenticated through the physiological characteristic authentication mode but has been authenticated through the auxiliary authentication mode. However, in the case that the current user is not an owner of the electronic device (e.g., in the case that another person who has picked up the user's electronic device or a guest who wants to use the user's electronic device), both the above two authentication modes may fail.

With respect to the above case, different means may be adopted, which will be described hereinafter in details.

In a possible embodiment of the present disclosure, the method may further include a first control step 105 of, in the case that the second authentication result indicates that the authentication is unsuccessful, controlling the electronic device to operate in a guest mode where the user is merely capable of using parts of functions of the electronic device.

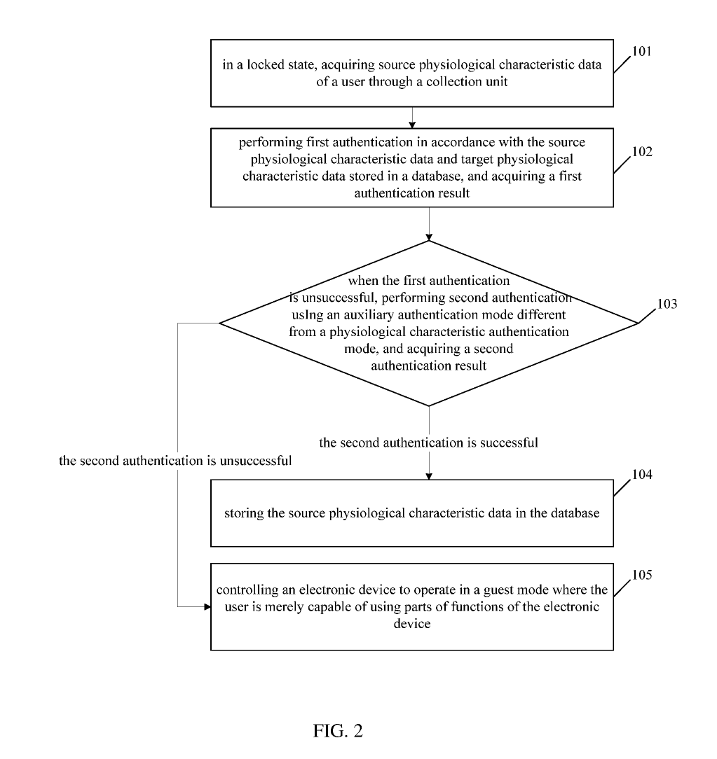

In other words, as shown in FIG. 2, the method may include: the acquisition step 101 of, in the locked state, acquiring the source physiological characteristic data of the user through the collection unit; the first authentication step 102 of performing the first authentication in accordance with the source physiological characteristic data and the target physiological characteristic data stored in the database, and acquiring the first authentication result; the second authentication step 103 of, in the case that the first authentication result indicates that the authentication is unsuccessful, performing the second authentication using the auxiliary authentication mode different from the physiological characteristic authentication mode, and acquiring the second authentication result; the storage step 104 of, in the case that the second authentication result indicates that the second authentication is successful, storing the source physiological characteristic data in the database; and the first control step 105 of, in the case that the second authentication result indicates that the authentication is unsuccessful, controlling the electronic device to operate in the guest mode where the user is merely capable of using parts of the functions of the electronic device.

In this way, the guest may use parts of the functions of the electronic device, so it is able to share the electronic device between the guest and the owner, and meanwhile achieve the other functions, e.g., protection of the privacy data. The other functions are those unavailable for the current user, which will be illustrated hereinafter.

For example, in the case that a checkbook, a game application unsuitable for kids (e.g., a game containing brutal scenes) and an educational application for kids are stored in a flat-panel computer and a child of the user fails to be authenticated, the child may still use the educational application, but may not use the checkbook (so as to prevent the child from modifying the checkbook), or the game application (so as to prevent the child from being adversely affected).

In this way, it is able to ensure the security of the user's data and protect the young users.

In addition, in the case that the user does not want any other person to know his family assets and the guest fails to be authenticated through the two authentication modes, merely the checkbook stored in the electronic device may not be used by the guest.

The functions unavailable for the guest may also include, but not limited to, a writing function, an application installation function and an access function to an electronic photo album.

In a possible embodiment of the present disclosure, the method may further include a second control step 106 of, in the case that the second authentication result indicates that the authentication is unsuccessful, performing a security control operation.

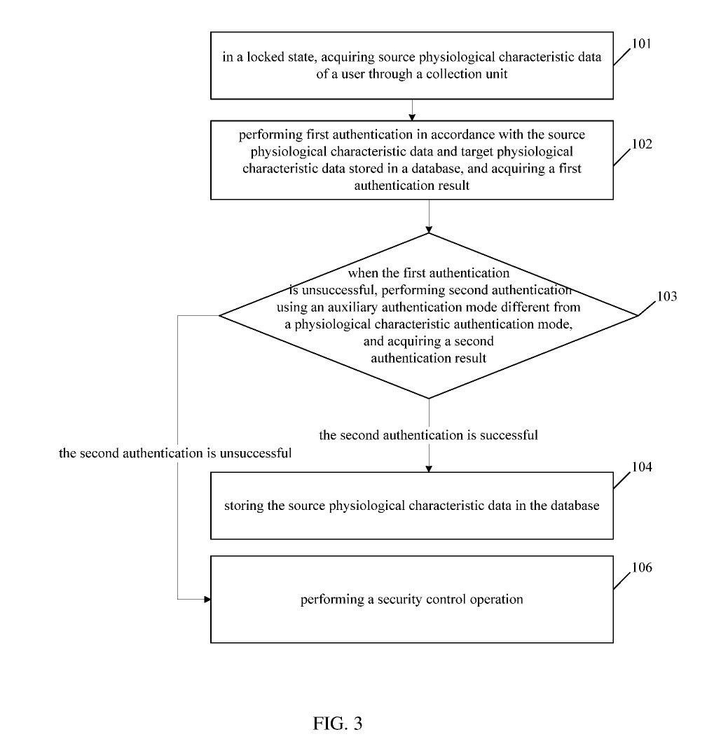

In other words, as shown in FIG. 3, the method may include: the acquisition step 101 of, in the locked state, acquiring the source physiological characteristic data of the user through the collection unit; the first authentication step 102 of performing the first authentication in accordance with the source physiological characteristic data and the target physiological characteristic data stored in the database, and acquiring the first authentication result; the second authentication step 103 of, in the case that the first authentication result indicates that the authentication is unsuccessful, performing the second authentication using the auxiliary authentication mode different from the physiological characteristic authentication mode, and acquiring the second authentication result; the storage step 104 of, in the case that the second authentication result indicates that the authentication is successful, storing the source physiological characteristic data in the database; and the second control step 106 of, in the case that the second authentication result indicates that the authentication is unsuccessful, performing the security control operation.

In some other embodiments of the present disclosure, in the case that the current user fails to be authenticated through the physiological characteristic authentication mode and the other authentication mode different from the physiological characteristic authentication mode, it means that the current user may be not the owner of the electronic device. At this time, the security control operation may be performed, so as to protect the electronic device and improve the security of the electronic device.

Through the security control operation after the authentication is not successful through the two authentication modes, it is able to ensure the user's benefit in the case that his electronic device is lost. The security control operation may include, but not limited to, an electronic device locking operation for preventing data leakage, a data wiping operation for prevent data leakage, and/or an alarm operation for the retrieval of the electronic device.

In the physiological characteristic authentication mode, in the case that the collection unit (e.g., a fingerprint collection unit) is of high precision, erroneous authentication may occur seldom. However, at this time, the collection unit is expensive, and thus the manufacture cost of the electronic device may increase. In order to reduce the manufacture cost, in some embodiments of the present disclosure, the collection unit of less precision may be used, and an error tolerance mechanism may be introduced so as to prevent the erroneous authentication.

In a possible embodiment of the present disclosure, the method may further include a trigger control step 107 of, in the case that the first authentication result indicates that the authentication is unsuccessful, determining whether or not the times of unsuccessful authentication are greater than a predetermined threshold, acquiring a determination result, and in the case that the determination result indicates that the times of unsuccessful authentication are greater than the predetermined threshold, entering the second authentication step, and otherwise returning to the acquisition step.

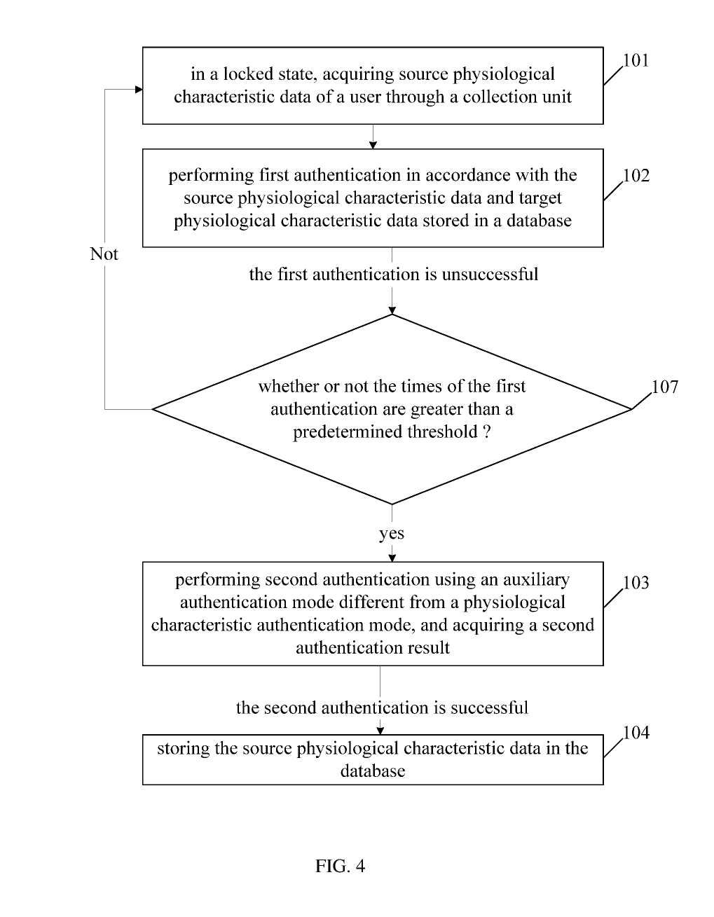

In other words, as shown in FIG. 4, the method may include: the acquisition step 101 of, in the locked state, acquiring the source physiological characteristic data of the user through the collection unit; the first authentication step 102 of performing the first authentication in accordance with the source physiological characteristic data and the target physiological characteristic data stored in the database, and acquiring the first authentication result; the trigger control step 107 of, in the case that the first authentication result indicates that the authentication is unsuccessful, determining whether or not the times of unsuccessful authentication are greater than the predetermined threshold, acquiring the determination result, and in the case that the determination result indicates that the times of unsuccessful authentication are greater than the predetermined threshold, entering the second authentication step 103, and otherwise returning to the acquisition step 101; the second authentication step 103 of, in the case that the first authentication result indicates that the authentication is unsuccessful, performing the second authentication using the auxiliary authentication mode different from the physiological characteristic authentication mode, and acquiring the second authentication result; and the storage step 104 of, in the case that the second authentication result indicates that the authentication is successful, storing the source physiological characteristic data in the database.

Considering that an error may occur for the collection and authentication of the physiological characteristic, the physiological characteristic authentication may be performed for several times, and in the case that the authentication times has reached the predetermined threshold, the physiological characteristic authentication may be deemed to be failed. Through the limit of the authentication times, it is able to reduce the requirements on the authentication precision for the electronic device, thereby to reduce the manufacture cost of the electronic device.

As mentioned above, in some embodiments of the present disclosure, the physiological characteristic authentication mode may be the fingerprint authentication mode. The auxiliary authentication mode may be an authentication mode performed on the basis of a user's operation collected by the touch panel. For example, a nine-square may be displayed on the touch panel and the user may perform trajectory input; or a virtual digital keyboard may be displayed on the touch panel and the user may select numbers through a touch operation; or a virtual full-character keyboard may be displayed on the touch panel and the user may select the character through a touch operation.

In some embodiments of the present disclosure, the fingerprint collection unit and the touch panel may be arranged separately, and at this time, the user need to perform the input operation twice, i.e., perform the fingerprint input operation through the fingerprint collection unit and perform the touch input operation through the touch panel.

In a possible embodiment of the present disclosure, in the case that the physiological characteristic authentication mode is the fingerprint authentication mode, the electronic device includes a touch panel and the auxiliary authentication mode is performed on the basis of the user's operation collected by the touch panel, the collection unit may be arranged in such a manner as to collect the fingerprint data in the case that user performs the touch operation for unlocking at the predetermined region.

In this way, it is able for the electronic device to identify the user's fingerprint while collecting the touch data, thereby to simplify the user's operation and improve the convenience of the electronic device.

In other words, in a possible embodiment of the present disclosure, in the case that the electronic device includes a touch panel, the physiological characteristic authentication mode is the fingerprint authentication mode and the auxiliary authentication mode is performed on the basis of the user's operation collected by the touch panel, the collection unit may be arranged at the predetermined region of the touch panel so that it is capable of collecting the fingerprint data in the case that the user performs the touch operation for unlocking at the predetermined region.

Taking the nine-square as an example, the fingerprint collection unit may be arranged at each box of the nine-square. In the case that the user performs the trajectory input on the touch panel, the fingerprint data may be acquired by the fingerprint collection units. In this way, it is able for the user to input two to-be-authenticated objects (fingerprint and trajectory) through a single operation, thereby to simplify the user's operation.

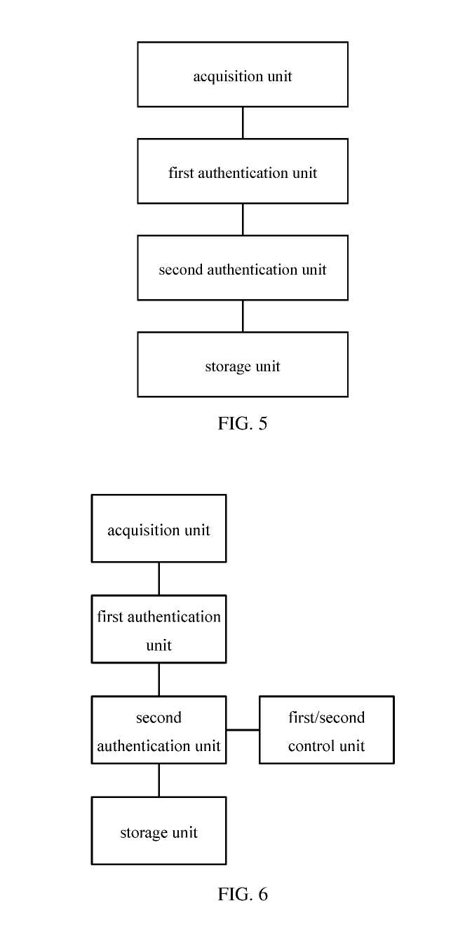

The present disclosure further provides in some embodiments an apparatus for controlling an electronic device. The electronic device includes a collection unit configured to collect source physiological characteristic data of a user. As shown in FIG. 5, the apparatus includes: an acquisition unit configured to, in a locked state, acquire the source physiological characteristic data of the user through the collection unit; a first authentication unit configured to perform first authentication in accordance with the source physiological characteristic data and target physiological characteristic data stored in a database, and acquire a first authentication result; a second authentication unit configured to, in the case that the first authentication result indicates that the authentication is unsuccessful, perform second authentication using an auxiliary authentication mode different from a physiological characteristic authentication mode, and acquire a second authentication result; and a storage unit configured to, in the case that the second authentication result indicates that the authentication is successful, store the source physiological characteristic data in the database.

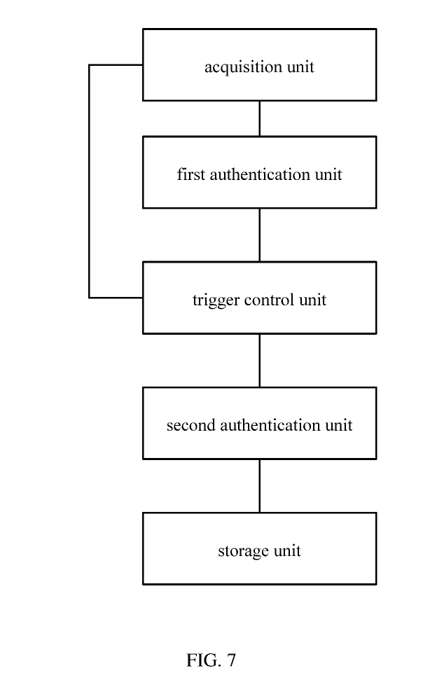

As shown in FIG. 6, the apparatus may further include: a first control unit configured to, in the case that the second authentication result indicates that the authentication is unsuccessful, control the electronic device to operate in a guest mode where the user is merely capable of using parts of functions of the electronic device; or a second control unit configured to, in the case that the second authentication result indicates that the authentication is unsuccessful, perform a security control operation.

As shown in FIG. 7, the apparatus may further include a trigger control unit configured to, in the case that the first authentication result indicates that the authentication is unsuccessful, determine whether or not the times of unsuccessful authentication are greater than a predetermined threshold, acquire a determination result, and in the case that the determination result indicates that the times of unsuccessful authentication are greater than the predetermined threshold, trigger the second authentication unit, and otherwise trigger the acquisition unit.

In a possible embodiment of the present disclosure, the electronic device further includes a touch panel, the physiological characteristic authentication mode is a fingerprint authentication mode, the auxiliary authentication mode is an authentication mode performed on the basis of a user's operation collected by the touch panel, and the collection unit is located at a predetermined region of the touch panel and is capable of collecting user's fingerprint data in the case that a touch operation for unlocking is made by the user at the predetermined region.

The present disclosure further provides in some embodiments an electronic device including a collection unit configured to collect source physiological characteristic data of a user, and the above-mentioned apparatus.

According to the embodiments of the present disclosure, the modules/units may be implemented by software, so as to be executed by various processors. For example, an identified, executable code module may include one or more physical or logical blocks including computer instructions, and the module may be constructed as an image, a process or a function. Even so, the executable codes of the identified modules are unnecessary to be physically located together, but may include different instructions stored in different locations. In the case that these instructions are logically combined together, they form the modules and achieve the prescribed purposes of the modules.

Actually, the executable code module may be a single instruction or a plurality of instructions, and may even be distributed at different code segments, in different programs, or across a plurality of memory devices. Also, operational data may be identified in the modules, implemented in any appropriate form, and organized in any data structure of an appropriate type. The operational data may be collected as a single data set, or distributed at different locations (including different memory devices), and may be at least partially present in a system or network merely as an electronic signal.

In the case that the modules are implemented by software, considering the current hardware level, a person skilled in the art may build a corresponding hardware circuit to achieve the corresponding function in the case of taking no account of the cost. The hardware circuit includes a conventional very-large-scale integration (VLSI) circuit, a gate array, an existing semiconductor such as a logic chip and a transistor, or other discrete components. The modules may further be implemented by a programmable hardware device, such as a field-programmable gate array, a programmable array logic device and a programmable logic device.

The above are merely the optional embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

1. A method for controlling an electronic device having a collection unit, the method comprising:
an acquisition step of, in a locked state, acquiring source physiological characteristic data of a user through the collection unit;
a first authentication step of performing first authentication in accordance with the source physiological characteristic data and target physiological characteristic data stored in a database, and acquiring a first authentication result;
a second authentication step of, in the case that the first authentication result indicates that authentication is unsuccessful, performing second authentication using an auxiliary authentication mode different from a physiological characteristic authentication mode, and acquiring a second authentication result; and
a storage step of, in the case that the second authentication result indicates that authentication is successful, storing the source physiological characteristic data in the database.

2. The method according to claim 1, further comprising a first control step of, in the case that the second authentication result indicates that authentication is unsuccessful, controlling the electronic device to operate in a guest mode where the user is merely capable of using parts of functions of the electronic device.

3. The method according to claim 1, further comprising a second control step of, in the case that the second authentication result indicates that authentication is unsuccessful, performing a security control operation.

4. The method according to claim 1, further comprising a trigger control step of, in the case that the first authentication result indicates that authentication is unsuccessful, determining whether or not the times of unsuccessful authentication are greater than a threshold, acquiring a determination result, and in the case that the determination result indicates that the times of unsuccessful authentication are greater than the threshold, entering the second authentication step, and otherwise returning to the acquisition step.

5. The method according to claim 1, wherein the electronic device further comprises a touch panel, the physiological characteristic authentication mode is a fingerprint authentication mode, the auxiliary authentication mode is an authentication mode performed on the basis of a user's operation collected by the touch panel, and the collection unit is located at a region of the touch panel and is capable of collecting user's fingerprint data in the case that a touch operation for unlocking is made by the user at the region.

6. The method according to claim 3, wherein the security control operation comprises an electronic device locking operation for preventing data leakage, a data wiping operation for prevent data leakage, and/or an alarm operation for the retrieval of the electronic device.

7. An apparatus for controlling an electronic device having a collection unit, the apparatus comprising:
an acquisition unit configured to, in a locked state, acquire source physiological characteristic data of a user through the collection unit;
a first authentication unit configured to perform first authentication in accordance with the source physiological characteristic data and target physiological characteristic data stored in a database, and acquire a first authentication result;
a second authentication unit configured to, in the case that the first authentication result indicates that authentication is unsuccessful, perform second authentication using an auxiliary authentication mode different from a physiological characteristic authentication mode, and acquire a second authentication result; and
a storage unit configured to, in the case that the second authentication result indicates that authentication is successful, store the source physiological characteristic data in the database.

8. The apparatus according to claim 7, further comprising a first control unit configured to, in the case that the second authentication result indicates that authentication is unsuccessful, control the electronic device to operate in a guest mode where the user is merely capable of using parts of functions of the electronic device.

9. The apparatus according to claim 7, further comprising a second control unit configured to, in the case that the second authentication result indicates that authentication is unsuccessful, perform a security control operation.

10. The apparatus according to claim 7, further comprising a trigger control unit configured to, in the case that the first authentication result indicates that authentication is unsuccessful, determine whether or not the times of unsuccessful authentication are greater than a threshold, acquire a determination result, and in the case that the determination result indicates that the times of unsuccessful authentication are greater than the threshold, trigger the second authentication unit, and otherwise trigger the acquisition unit.

11. The apparatus according to claim 7, wherein the electronic device further comprises a touch panel, the physiological characteristic authentication mode is a fingerprint authentication mode, the auxiliary authentication mode is an authentication mode performed on the basis of a user's operation collected by the touch panel, and the collection unit is located at a region of the touch panel and is capable of collecting user's fingerprint data in the case that a touch operation for unlocking is made by the user at the region.

12. The apparatus according to claim 9, wherein the security control operation comprises an electronic device locking operation for preventing data leakage, a data wiping operation for prevent data leakage, and/or an alarm operation for the retrieval of the electronic device.

13. An electronic device, comprising a collection unit configured to collect source physiological characteristic data of a user, and the apparatus according to claim 7.

14. The electronic device according to claim 13, wherein the apparatus further comprises a first control unit configured to, in the case that the second authentication result indicates that authentication is unsuccessful, control the electronic device to operate in a guest mode where the user is merely capable of using parts of functions of the electronic device.

15. The electronic device according to claim 13, wherein the apparatus further comprises a second control unit configured to, in the case that the second authentication result indicates that authentication is unsuccessful, perform a security control operation.

16. The electronic device according to claim 13, wherein the apparatus further comprises a trigger control unit configured to, in the case that the first authentication result indicates that authentication is unsuccessful, determine whether or not the times of unsuccessful authentication are greater than a threshold, acquire a determination result, and in the case that the determination result indicates that the times of unsuccessful authentication are greater than the threshold, trigger the second authentication unit, and otherwise trigger the acquisition unit.

17. The electronic device according to claim 13, wherein the electronic device further comprises a touch panel, the physiological characteristic authentication mode is a fingerprint authentication mode, the auxiliary authentication mode is an authentication mode performed on the basis of a user's operation collected by the touch panel, and the collection unit is located at a region of the touch panel and is capable of collecting user's fingerprint data in the case that a touch operation for unlocking is made by the user at the region.

18. The electronic device according to claim 15, wherein the security control operation comprises an electronic device locking operation for preventing data leakage, a data wiping operation for prevent data leakage, and/or an alarm operation for the retrieval of the electronic device.
